(19) United States
(12) Patent Application Publication
(10) Pub. No.: US 2014/0051006 A1
(43) Pub. Date: Feb. 20, 2014

(54) METAL SUPPORTED SOLID OXIDE FUEL CELL AND METHOD FOR MANUFACTURING THE SAME

(71) Applicant: ATOMIC ENERGY COUNCIL-INSTITUTE OF NUCLEAR ENERGY RESEARCH, (US)

(72) Inventors: CHANG-SING HWANG, TAOYUAN COUNTY 325 (TW); CHUN-LIANG CHANG, YUNLIN COUNTY 640 (TW); CHIH-MING CHUANG, TAICHUNG CITY 412 (TW); CHUN-HUANG TSAI, PINGTUNG COUNTY 928 (TW); SHENG-HUI NIEN, TAOYUAN COUNTY (TW); SHIH-WEI CHENG, NEW TAIPEI CITY 221 (TW)

(73) Assignee: ATOMIC ENERGY COUNCIL-INSTITUTE OF NUCLEAR ENERGY RESEARCH, Taoyuan County (TW)

(21) Appl. No.: 13/886,854

(22) Filed: May 3, 2013

(30) Foreign Application Priority Data
Aug. 16, 2012 (TW) 101129823

(51) Int. Cl. H01M 8/10

(52) U.S. Cl. CPC H01M 8/1097; H01M 8/1002
USPC 429/481; 427/446; 429/535

(57) ABSTRACT

Metal supported solid oxide fuel cells produced by high voltage medium current tri-gas atmospheric plasma spraying are revealed. These fuel cells have better electrical properties, better redox stability, better durability and higher thermal conductivity due to the metal support. Moreover, nano structure of an anode interlayer and nano structure of a cathode interlayer have more three-phase boundaries (TPB) so that performance of the solid oxide fuel cell is improved and the working temperature of the solid oxide fuel cell is reduced. The shape of the solid oxide fuel cell is planar or tubular.

### FIELD OF THE INVENTION

The present invention relates to a metal supported solid oxide fuel cell and a method for manufacturing the same, especially to a metal supported solid oxide fuel cell produced by high voltage (>87V) medium current (<510 A) tri-gas atmospheric plasma spraying (APS).

### BACKGROUND OF THE INVENTION

Solid oxide fuel cells are electrochemical conversion devices that generate electricity. Generally air or oxygen gas is introduced and reacted with hydrogen gas to produce water and electricity. The device is with high efficiency and low pollution. Materials for electrolytes, anodes and cathodes are revealed in many papers such as Appleby “Fuel cell technology: Status and future prospects”, Energy, 21, 521, 1996, Singhal, “Science and technology of solid-oxide fuel cells”, MRS Bulletin, 25, 16, 2000, Williams, “Status of solid oxide fuel cell development and commercialization in the U.S.”, Proceedings of 6th International Symposium on Solid Oxide Fuel Cells (SOFC VI), Honolulu, Hi., 3, 1999, Hujismans et al., “Intermediate temperature SOFC—a promise for the 21th century”, J. Power Sources, 71, 107, 1998, etc. The electrolyte is Yttria Stabilized Zirconia (YSZ) while the anode is made from Ni/YSZ cermet and the cathode is made from perovskite LaMnO₃.

However, YSZ generates sufficient ionic conductivity only at high working temperature ranging from 900° C. to 1000° C. Thus the solid oxide fuel cell is made from high temperature resistant expensive materials. This leads to high manufacturing cost and difficulty in mass production.

In order to solve the above problem, a thinner electrolyte layer made from YSZ (about 5 μm) is used to reduce its resistance and loss at the working temperature lower than 900° C. Or the YSZ is replaced by other electrolyte materials that provide high ionic conductivity in medium temperature range 600˜800° C. such as strontium- and magnesium-doped lanthanum gallate (LSGM). With easier manufacturing techniques and cheaper materials, a solid oxide fuel cell stack is produced with lower cost.

However, when the working temperature of the solid oxide fuel cell is decreased to about 600° C., the ionic conductivity of the YSZ with the thickness of 5 μm is too low to be used. Thus other materials with high ionic conductivity such as gadolinium doped ceria (GDC) and strontium- and magnesium-doped lanthanum gallate (LSGM) are used as electrolytes.

Moreover, when the temperature is decreased, the electrochemical activity of the cathode and the anode is also reduced. This causes increasing in polarization resistance of both the cathode and the anode and the energy loss is also increased. Thus new materials for the cathode and the anode are required. For example, the cathode can be made from LSCF (La_{0.6}Sr_{0.4}Co_{0.2}Fe_{0.8}O₃) while the anode is made from GDC/Ni or LDC (Lanthanum doped Ceria)/Ni.

As to the structure of the anode, refer to Virkar, “Low-temperature anode-supported high power density solid oxide fuel cells with nano structured electrodes”, Fuel Cell Annual Report, 111, 2003, it revealed that an anode of the solid oxide fuel cell made from Ni/YSZ cermet is composed of a thinner fine-pore layer and a thicker coarse-pore layer. The smaller the size of the pores in the fine-pore layer, the better performance the solid oxide fuel cell is. Once the pore size is in nano scale, the number of three-phase boundaries (TPB) is increased effectively. However, the research did not disclose details of properties of the nano structure the thinner fine-pore layer has.

Furthermore, refer to the article Wang, “Influence of size of NiO on the electrochemical properties for SOFC anode”, Chemical Journal of Chinese Universities, Chinese researchers Wang. Etc. revealed an anode of the solid oxide fuel cell made from cermet with advantages of increased number of TPB and reduced energy loss of the electrode is disclosed. A mixture of nano scale NiO and micron YSZ is shaped into pallets and treated by hydrogen reduction to form the anode. Yet the nano structure of the anode is not disclosed concretely.

As to the electrolyte layer, the thicker it is, the larger the internal resistance of the solid oxide fuel cell is. Thus the energy loss inside the cell is increased and the output power is decreased. Especially when the working temperature of the solid oxide fuel cell is lower than 700° C., resistance energy loss of the electrolyte becomes main energy loss of the solid oxide fuel cell. In order to increase the output power, the thickness of the electrolyte layer needs to be decreased or the ionic conductivity of the electrolyte needs to be increased.

Generally, there is a plurality of methods for producing solid oxide fuel cells including Chemical Vapor Deposition. Electrochemical vapor deposition, sol-gel method, tape casting, screen printing, physical vapor deposition (PVD), spin coating, plasma spray, etc. During these methods, the tape casting, the screen printing, and the spin coating need to be combined with several high temperature sintering processes that cause warps and cracks of the solid oxide fuel cell. Moreover, the high temperature sintering process is often applied to produce dense electrolyte layers and get better contact between the electrolyte layer and the electrode layer. But the high temperature sintering process makes the porous electrode layer lose mass transfer function while becoming denser. Moreover, the high temperature sintering process also causes chemical reactions between the electrolyte layer and the electrode layer which has negative effect on performance of the cell. For example, the LSGM in the electrolyte layer and the nickel element in the anode interlayer react to generate insulating La—Ni oxide (LaNiO3) at high temperature and this causes increasing internal resistance of the solid oxide fuel cell, as shown in Zhang et al., “Interface reactions in the NiO-SDC-LSGM system”, Solid State Ionics, 139, 145, 2001.

In addition, when the thickness of the electrolyte layer made from LSGM is 20 μm or smaller, the cobalt element in LSCF (La_{0.6}Sr_{0.4}Co_{0.2}Fe_{0.8}O₃) of the cathode will be diffused to the LSGM electrolyte layer during the high temperature sintering process. Thus the LSGM electrolyte becomes an electron conductor. This causes internal leakages in the solid oxide fuel cell so that the open circuit voltage is smaller than 1 Volt. The manufacturing process including high temperature sintering has many disadvantages.

Refer to US Pat. Pub. App. No. 20040018409, a solid oxide fuel cell manufactured by two gas atmospheric plasma spraying (APS) with low voltage (smaller than 70V) and high current (larger than 700 A) is revealed. The thickness of a LSGM electrolyte layer in the cell should be larger than 60 μm so that the open circuit voltage obtained is larger than 1V. The arc root on the anode nozzle of the plasma spray gun may move along in gas flow direction so that there is a variation of voltage difference ΔV of the plasma spray gun. Thus error ratio V/V of the working voltage of the plasma spray gun is increased and this has negative effect on heating the injected powders which should be heated evenly and stably. Moreover, this prior art adds PVA organic binder into nano particles whose size is smaller than 100 nm to form agglomerated micron powder clusters with nano structure. Then the powder clusters are pre-sintered to remove the PVA organic binder and form porous micron powder cluster with nano structure. Next the unscreened powder clusters are directly injected into the plasma flame of two gas atmospheric plasma spraying to form a film on a substrate. However, due to the pre-sintering process of powder clusters, the nano particles in the powder cluster are closely connected together so that the surface areas of the nano particles of the pre-sintered powder clusters in contact with the high temperature plasma flame are reduced. Thus the injected powder clusters can not be heated easily, evenly and effectively by the plasma flame and the film quality formed by these powder clusters is not meet the application requirement. Furthermore, as the unscreened powder clusters with a larger particle size distribution are injected into the plasma flame, the smaller particles and the larger particles have their trajectories off the high temperature region of the plasma flame and are not be heated enough to molten state, then they degrade the gas tightness required by the electrolytes of solid oxide fuel cells. There is also a chance to have small-size powder clusters overheated and then the property of these powder clusters degrades.

Refer to the paper Changsing Hwang, et. al., “Formation of nano structured YSZ/Ni anode with pore channels by plasma spraying”, Surface and Coating Technology, 201(12), 5954, 2007, and U.S. Pat. No. 8,053,142, although these prior arts have revealed the advantages of the anode with nano structure, these are limited to only one anode, not fuel cells, and the anode is unable to generate power. Moreover, a button cell with a diameter of 2.4 cm has been disclosed in the paper—Changsing Hwang, et. al., “Plasma sprayed metal supported YSZ/Ni-LSGM-LSCF ITSOFC with nano structured anode” Journal of Power Sources, 180, 132, 2008. The cell has low practical value and many other disadvantages such as high degradation rate, low generation power at 700° C., etc. Moreover, in the U.S. Pat. No. 8,241,812, a solid oxide fuel cell with a manufacturing method has been disclosed by Changsing Hwang, et. al, the disclosed solid oxide fuel cell had a planar structure with the anode related layers close to the metal frame and they used high voltage medium current Ar—He—H₂ tri-gas atmospheric plasma spraying method to fabricate all functional layers of cells. In the case that the injected powders used for fabricating a functional layer of cell can significantly react with hydrogen contained in the high temperature plasma flame through hydrogen reduction reaction and produce impurity phases in the fabricated functional layers of cells, it is adviced to use high voltage medium current Ar—He—N₂ tri-gas atmospheric plasma spraying method instead.

### SUMMARY

Therefore it is a primary object of the present invention to provide a metal supported solid oxide fuel cell with better electrical properties, re-oxidative stability and durability. Moreover, the metal supported solid oxide fuel cell has high thermal conductivity due to the supported metal. The shape of the fuel cell is plate-like or tubular.

It is another object of the present invention to provide a method for manufacturing a metal supported solid oxide fuel cell that improves coating quality and efficiency by a high voltage medium current tri-gas atmospheric plasma spraying process. The plasma gas includes argon, helium and hydrogen, or argon, helium and nitrogen.

It is a further object of the present invention to provide a method for manufacturing a metal supported solid oxide fuel cell that screens and sorts power cluster to be injected into a plurality of groups including 10˜20 μm, 20˜30 μm, 30˜50 μm and 50˜70 μm according to the particle size. There is no limit on the number of the groups. During the plasma spray coating, only one of the powder cluster groups is selected and a specific power for plasma spraying is used to avoid the insufficient heating of large-size powder clusters or the overheating of small-size powder clusters.

In order to achieve the above objects, a metal supported solid oxide fuel cell of the present invention includes a metal frame, a porous metal substrate set in the metal frame, a first anode separator layer disposed over the porous metal substrate, an anode interlayer arranged over the first anode separator layer and having a porous nano structure, an electrolyte layer set over the anode interlayer, a cathode interlayer disposed over the electrolyte layer and having a porous nano structure, and a cathode current collecting layer disposed over the cathode interlayer. It is also possible to combine the cathode interlayer and the cathode current collecting layer to be one layer that has the functions of both layers. As to the method for manufacturing a metal supported solid oxide fuel cell, it consists of following steps. Firstly, prepare a plurality of powder clusters used in plasma spray torches. Then sieve and sort the powder clusters into a plurality of groups according to particle sizes. Next deposit the powder clusters on a porous metal substrate by plasma spraying in turn to form a plurality of layers including a first anode separator layer, an anode interlayer, an electrolyte layer, a cathode interlayer, and a cathode current collecting layer over the porous metal substrate. Thus a metal supported solid oxide fuel cell with better electrical properties and high thermal conductivity is obtained by the above method. Moreover, in the case that the sequence of coated layers is reversed, then the cathode related layers are firstly coated over the porous metal substrate, and then the electrolyte layer and anode related layers are coated over the electrolyte layer.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1A is a schematic drawing showing structure of an embodiment of a planar cell according to the present invention;

FIG. 1B is a schematic drawing showing nano structure of an anode interlayer of an embodiment according to the present invention;

FIG. 2 is a schematic drawing showing structure of another embodiment of a planar cell according to the present invention;

FIG. 3 is a flow chart showing manufacturing steps of an embodiment according to the present invention;

FIG. 4 is a flow chart showing manufacturing steps of a porous metal substrate according to the present invention;

FIG. 5 is a flow chart showing manufacturing steps of another embodiment according to the present invention;

FIG. 6A shows performance of a single cell performance of a single cell of an embodiment according to the present invention;

FIG. 6B shows performance degradation of an embodiment according to the present invention;

FIG. 7A is a schematic drawing showing structure of an embodiment of a tubular cell according to the present invention;

FIG. 7B is a schematic drawing showing structure of another embodiment of a tubular cell according to the present invention.

### DETAILED DESCRIPTION

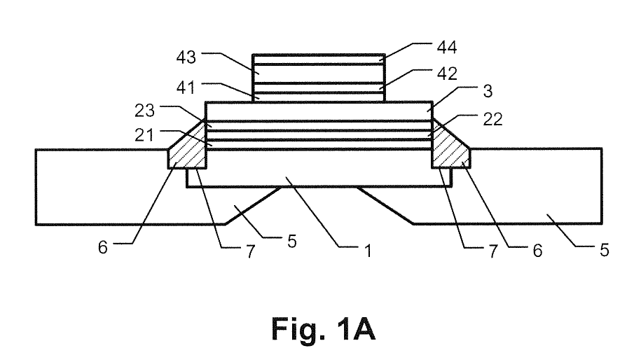

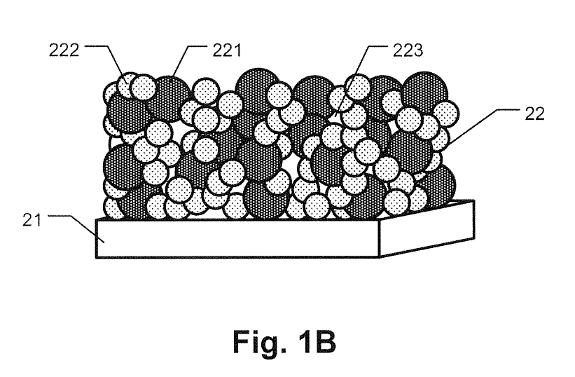

Refer to FIG. 1A, a schematic drawing showing structure of a metal-supported solid oxide fuel cell is revealed. As shown in figure, the metal-supported solid oxide fuel cell includes a metal frame 5, a porous metal substrate 1, a first anode separator layer 21, an anode interlayer 22, an electrolyte layer 3, a cathode interlayer 42, and a cathode current collecting layer 43. It is also possible to combine the cathode interlayer 42 and the cathode current collecting layer 43 to be only one layer that has the functions of both layers.

The porous metal substrate 1 is disposed in the metal frame 5 and is fixed therein by laser welding. The first anode separator layer 21 is disposed over the porous metal substrate 1 and the anode interlayer 22 is disposed over the first anode separator layer 21. The electrolyte layer 3 is disposed over the anode interlayer 22 while the cathode interlayer 42 is disposed over the electrolyte layer 3. As to the cathode current collecting layer 43, it is disposed over the cathode interlayer 42.

Beside the above components, the present invention further includes a second anode separator layer 23 arranged between the anode interlayer 22 and the electrolyte layer 3, a first cathode separator layer 41 arranged between the electrolyte layer 3 and the cathode interlayer 42, a second cathode separator layer 44 disposed over the cathode current collecting layer 43, and a groove 7 located on a connection position between the porous metal substrate 1 and the metal frame 5 and used for being filled with sealing materials 6. This sealing materials 6 is in contact with the electrolyte layer 3 to avoid gas leakages through the groove 7 and the edges of porous layers beneath the electrolyte layer 3.

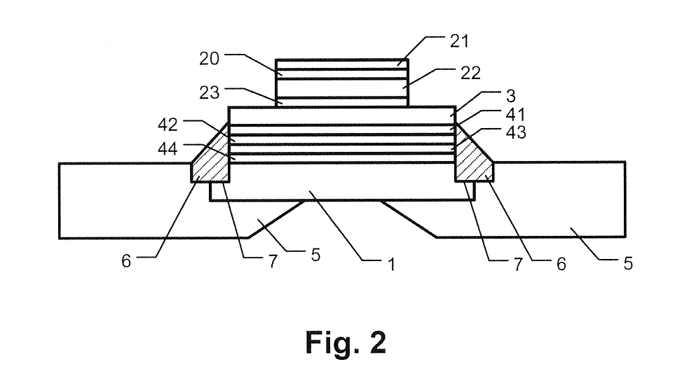

The above functional layers of the present invention can also be arranged in another way. Refer to FIG. 2, a cathode separator layer is disposed over the porous metal substrate 1. This cathode separator layer is the second cathode separator layer 44 shown in FIG. 1A. Then the cathode current collecting layer 43, the cathode interlayer 42, the first cathode separator layer 41, the electrolyte layer 3, the second anode separator layer 23, the anode interlayer 22, an anode current collecting layer 20 and the first anode separator layer 21 are stacked over the second cathode separator layer 44 in turn. In FIG. 2, it is possible to combine the cathode interlayer 42 and the cathode current collecting layer 43 to be only one layer that has the functions of both layers, and it is also possible to omit any of separator layers in the case that no deleterious interface reaction, such as the reaction between metal substrate 1 and cathode current collecting layer 43, or the reaction between cathode interlayer 42 and electrolyte layer 3, or the reaction between electrolyte layer 3 and anode interlayer 22, occurs.

In the embodiment shown in FIG. 1 and FIG. 2, the anode interlayer 22 is made from composite material of electron conducting nano particles and nano particles with good oxygen ion conductivity. The electron conducting nano particles are metal nano particles such as nickel, copper, cobalt, mixture of nickel and copper, or mixture of nickel, copper, and cobalt while nano particles with good oxygen ion conductivity are metal oxide nano particles such as yttria stabilized zirconia (YSZ), Lanthanum-doped ceria (LDC), Gadolinia-doped ceria (GDC), Samaria-doped Ceria (SDC), strontium and magnesium-doped lanthanum gallate (LSGM) or strontium, magnesium and cobalt-doped lanthanum gallate (LSGMC). In other words, the anode interlayer 22 is made from nano composite materials including YSZ/Ni (Ni particles dispersed in YSZ), LDC/Ni, GDC/Ni, SDC/Ni, etc. The materials for the anode interlayer 22 can also be added with other element such as molybdenum (Mo) or palladium (Pd), or can be added with other material such as perovskite La_{0.75}Sr_{0.25}Cr_{0.5}Mn_{0.5}O₃ or double perovskite Sr₂MgMoO₆ that has reduction-oxidation (redox) stability and can turn hydrocarbon compounds into hydrogen.

The anode interlayer 22 is has nano structure with a plurality of nano scale three-phase boundaries (TPB). The three-phase boundaries are formed by the following three parts of nano pores 223, oxygen ion conducting nano particles 222 such as YSZ, LDC, GDC, SDC, etc., and electron conducting nano particles 221 including nickel nano particles, copper nano particles, Cu—Ni nano composite or Cu—Co—Ni nano composite, and others. The nano scale TPB can increase the electrochemical activity and conductivity of anode interlayer 22 so as to reduce power loss. Moreover, the metal nano particles connect to form an electron conducting 3-dimensional (3D) network, the metal oxide nano particles connect to form an oxygen ion conducting 3-dimensional (3D) network, and the nano pores between the metal nano particles and the metal oxide nano particles connect to form a 3-dimensional network for flowing gas. These three networks mentioned above are crossed and mixed together. The network formed by connected metal oxide nano particles that wrap around the metal nano particles has sufficient strength to separate the metal nano particles and prevent aggregation of the metal nano particles. To insure a sufficient number of metal oxide nano particles around the metal nano particles, the metal nano particles is usually 2-5 times larger than the metal oxide nano particles and the volume percentage of metal oxide nano particles in the anode interlayer 22 is at least 35%. The anode interlayer 22 with such structure can reduce enlargement of the metal nano particles (such as nickel particles) due to aggregation under high temperature operation environment so as to increase the lifetime of anode interlayer 22. Furthermore, in the anode interlayer 22, the electron conducting metal nano particles and the oxygen ion conducting metal oxide nano particles are distributed evenly in a volume ratio of 50%:50%. The volume ratio can also be in a gradient distribution. That means the amount of the electron conducting nano particles is increasing in the area getting closer to the porous metal substrate.

The cathode interlayer 42 is an electron-oxygen ion mixed conducting layer made from two kinds of materials and having a structure similar to the anode interlayer 22. The cathode interlayer 42 is a mixture of a plurality of electron-oxygen ion mixed conducting nano/submicron scale particles, a plurality of oxygen ion conducting nano particles and a plurality of nano or submicron pores between the electron-oxygen ion mixed conducting particles and the oxygen ion conducting nano particles. The electron-oxygen ion mixed conducting nano/submicron scale particles connect to form a 3D network for conducting electron and oxygen ion, the oxygen ion conducting nano particles connect to form a 3D network for conducting oxygen ion additionally and the connected nano or submicron pores also form a 3D network for flowing gas. These three 3D networks are crossed and mixed together. The mixed materials include a mixture of LSGM/LSCF, a mixture of LSGMC/LSCF, a mixture of GDC/LSCF, a mixture of LDC/LSCF, and a mixture of SDC/LSCF. The above LSCF can be replaced by PSCF (Pr_{0.6}Sr_{0.4}Co_{0.2}Fe_{0.8}O₃), SSC (Sm_{0.5}Sr_{0.5}CoO₃), BSCF (Ba_{0.5}Sr_{0.5}Co_{0.2}Fe_{0.8}O₃), BPCF (Ba_{0.5}Pr_{0.5}Co_{0.2}Fe_{0.8}O₃), lanthanum strontium cobalt oxide (LSCo), lanthanum strontium ferrite (LSF), etc. The LSGM or LSGMC powder are submicron or nano particles. The common-used LSCF, PSCF, LSCo, LSF, BSCF SSC and BPCF powder are submicron powder/particles (200˜400 nm) while common-used GDC, SDC and LDC powder are nano particles.

Similarly, the cathode interlayer 42 also includes nano scale or submicron scale TPB formed by pores, electron-oxygen ion mixed conducting particles and oxygen ion conducting nano particles so as to have better electrochemical activity and electrical conductivity. Moreover, the cathode interlayer 42 can also be a layer formed only by an electron-oxygen ion mixed conducting material such as LSCF material. If the cathode interlayer 42 is composed of two kinds of materials, then it is formed by an oxygen ion conducting electrolyte material and an electron-oxygen ion mixed conducting material in a volume ratio of 50%:50% or in a gradient distribution. The oxygen ion conducting electrolytes include LSGM, LSGMC, GDC, SDC, and LDC while the electron-oxygen ion mixed conducting materials consist of LSCF, PSCF. SSC, BSCF, BPCF, LSCo and LSF. If the composition of cathode interlayer 42 is in a gradient distribution, the amount of the nano particles of oxygen ion conducting electrolytes increases in the area closer to the electrolyte layer 3.

The thickness of the anode interlayer 22 is ranging from 10 μm to 30 μm while 15˜25 μm is preferred. The porosity of the anode interlayer 22 is 15˜30%. The thickness of the cathode interlayer 42 is between 15 μm and 40 μm and 20˜30 μm is preferred. The porosity of the cathode interlayer 42 is 15˜30%. The anode interlayer 22 and the cathode interlayer 42 are homogeneous mixtures formed by two kinds of materials in a volume ratio of 50%:50%, or formed by two kinds of materials in a gradient distribution so that a good match of thermal expansion coefficient between the electrolyte layer and the current collecting layer of cathode or anode is obtained.

Refer to FIG. 1A and FIG. 2, the porous metal substrate 1 allows reaction gas such as hydrogen to pass through. However, the porous property makes the porous metal substrate 1 have insufficient support strength. Thus the present invention uses gas tight metal frame 5 to support the porous metal substrate 1 and increase the structure strength of the solid oxide fuel cell. The shape of the metal frame 5 is in correspondence with the shape of the porous metal substrate 1 and they can be planar or tubular in shape. The planar metal frame 5 is disposed around the planar porous metal substrate 1 while the tubular metal frame 5 is disposed at each of two ends of the tubular porous metal substrate 1.

The porous metal substrate 1 shown in FIG. 1A is used in the reduction environment, such as the environment containing hydrogen, and is made from nickel, molybdenum, iron, copper or their alloys. The alloys include nickel-iron alloy, nickel-copper alloy, nickel-iron-copper alloy, nickel-molybdenum alloy, and nickel-molybdenum-iron alloy while the weight percent of the iron is less than 20%. These irons in the porous metal substrate 1 can absorb the oxygen efficiently by iron oxidation reaction so as to increase the redox stability of the fuel cell supported by this porous metal substrate 1. Moreover, the porous metal substrate 1 shown in FIG. 2 is used in the oxidation environment, such as the environment containing oxygen, and includes porous ferritic stainless steel substrates and porous nickel alloy substrates containing iron, molybdenum and chromium. The porosity of the porous metal substrate 1 can be up to 30˜55% by acid etching and the permeability can be increased to 2˜5 Darcy. The thickness of the porous metal substrate 1 is from 1 mm to 2 mm and the area thereof is from 2.5×2.5 cm² to 20×20 cm². Yet there is no specific restriction on the area or structure of the porous metal substrate 1. The permeable porous metal substrate 1 with certain strength is formed by high temperature sintering a substrate green body in a reducing atmosphere.

As shown in the FIG. 1A, the first anode separator layer 21 is deposited over the porous metal substrate 1 and other layers are deposited thereon in sequence. When the pore size (diameter) on the surface of the porous metal substrate 1 is larger than 50 μm, it is difficult to have the deposited electrolyte layer to be pinhole free and gas tight. Thus the present invention further includes a powder coating layer (not shown in FIG. 1A) formed over the porous metal substrate 1 with a thickness smaller than 40 μm, and the material of the powder coating layer is the same as the porous metal substrate. The pore sizes of a plurality of pores on the powder coating layer are smaller than 50 μm. The preferred pore sizes are smaller than 30 μm. Similarly, refer to FIG. 2, there is also a powder coating layer (not shown in FIG. 2) formed over the porous metal substrate 1 with the thickness smaller than 40 μm. The pore sizes of a plurality of pores on this powder coating layer are smaller than 50 μm and the preferred pore sizes of this powder coating layer are smaller than 30 μm.

The materials for the metal frame 5 can be gas tight stainless steel with superior oxidation and corrosion resistances such as ferritic stainless steel, iron-chromium alloy, iron-chromium-nickel alloy or iron-chromium-molybdenum alloy. Moreover, under the high temperature atmospheres of fuel cells, the metal frame 5 contacts air oxidant and hydrogen fuel simultaneously so that it must have superior oxidation and reduction resistances. The common thickness of the metal frame 5 is 2 mm to 3 mm and the thermal expansion coefficient of metal frame 5 is within 1.0×10⁻⁵˜1.4×10⁻⁵/° C. to match with the thermal expansion coefficients of porous metal substrate 1 and other layers on the porous metal substrate 1. The surface of the metal frame 5 is coated with a protective layer (not shown in FIG. 1A and FIG. 2) although the metal frame 5 does not directly contact any layer of fuel cell so as to prevent chromium poison of the cathode interlayer 42 and the cathode current collecting layer 43. The materials for the protective layer include manganese-cobalt spinel or lanthanum strontium manganese (LSM). Furthermore, the cathode current collecting layer 43 can be coated with a second cathode separator layer 44 which is in contact with a metal interconnect according to users' needs, as shown in FIG. 1A. The common materials for the second cathode separator layer 44 include LSCM (La_{0.75}Sr_{0.25}Cr_{0.5}Mn_{0.5}O₃) or other perovskite such as La_{0.6}Sr_{0.2}Ca_{0.2}CrO₃, and La_{0.75}Sr_{0.25}Co_{0.5}Mn_{0.5}O₃ (LSCoM) and with a permeable porous structure and a thickness of 10˜30 μm. If there is no chromium diffused from the metal interconnect to the cathode interlayer 42 and the cathode current collecting layer 43, there is no need to dispose the second cathode separator layer 44.

In an embodiment of the present invention, the metal frame 5 and the porous metal substrate 1 are connected and integrated together by laser welding. The way of connecting the porous metal substrate 1 and the metal frame 5 is not limited. By the proper alignment of the metal frame 5, a plurality of metal-supported solid oxide fuel cells are easier to be stacked into a cell stack. Moreover, the connection place between the porous metal substrate 1 and the metal frame 5 can be designed into a structure like groove 7 for being filled with sealing materials 6. The sealing materials 6 filled in the groove 7 to cover the welded positions increases the gas tightness of these positions and is in contact with the electrolyte layer 3 to avoid gas leakages through the edges of porous layers beneath the electrolyte layer 3.

The structure of the electrolyte layer 3 can be single-layer, double-layer or multiple-layer made from LSGM, LDC, GDC, SDC, or LSGMC or a mixture from two of them. The preferred mixtures are made by LSGM with LDC, or GDC or SDC, or by LSGMC with LDC, or GDC or SDC. Taking an electrolyte layer 3 as a single layer structure, it is formed by one of different ion-conducting materials such as LSGM, LSGMC, LDC, GDC and SDC. For an electrolyte layer 3 with a double layer structure, it is formed by different ion-conducting materials such as LDC-LSGM, GDC-LSGM, SDC-LSGM or LSGMC-LSGM. For an electrolyte layer 3 with a three-layer structure, it can be LDC-LSGM-LDC, LDC-LSGM-GDC, LDC-LSGM-SDC or LDC-LSGM-LSGMC. In the above examples, the LSGM can be replace by a mixture of LSGM and LDC or LSGM and GDC or LSGM and SDC, and the LSGMC can be replace by a mixture of LSGMC and LDC or LSGMC and GDC or LSGMC and SDC, The thickness and sequence of each layer are determined according to practical needs. Generally, the common thickness of LDC, GDC, SDC, LSGMC or LSGM is ranging from 5 μm to 50 μm. The total thickness of the electrolyte layer 3 should be kept as small as possible, but it is preferred in a range from 20˜55 μm to have enough mechanic strength. It is important that the second anode separator layer 23 and the first cathide separator layer 41 can be removed if the solid oxide fuel cell works well at the lower temperature such as under 700° C. and without poor interfacial reaction. Once the solid oxide fuel cell works at the temperature over 700° C. and has an unfavorable interfacial reaction occurred, the second anode separator layer 23 is disposed between the anode interlayer 22 and the electrolyte layer 3, or the first cathode separator layer 41 is arranged between the cathode interlayer 42 and the electrolyte layer 3. The materials for these separator layers are materials not reacting with adjacent layer and with good oxygen ion conductivity such as LDC, GDC, yttria doped ceria (YDC), etc. Similarly, the second cathode separator layer 44 in FIG. 1A can be added or removed according to application conditions. If there is no cathode poisoning in the cell, the second cathode separator layer 44 is removed, otherwise it should be disposed.

The cathode current collecting layer 43 is a submicron or micron porous structure and materials for the cathode current collecting layer 43 include submicron/micron LSCF powder, submicron/micron PSCF powder, submicron/micron LSCo powder, submicron/micron LSF powder, submicron/micron SSC powder, submicron/micron BSCF powder, submicron/micron BPCF powder or their combinations or mixtures in a certain ratio. The above materials can be added with a certain amount of electrolyte such as LDC, SDC or LSGMC for reducing the expansion coefficient of the cathode current collecting layer 43. In this embodiment, the thickness of the cathode current collecting layer 43 is from 20 μm to 50 μm while 30˜40 μm is preferred. The porosity of the cathode current collecting layer 43 is from 30 to 50%. The cathode current collecting layer 43 can also be made from materials with good electron-conductivity, long term stability and lower oxygen ion conducting property such as La_{0.7}Sr_{0.3}MnO₃ (LSM) perovskite, but some electrolyte material can be added to enhance oxygen ion conducting property. The commonly used material has the electron-oxygen ion mixed conductivity. The materials for the cathode current collecting layer 43, the thickness and the porosity of the cathode current collecting layer 43 are not restricted.

In addition, the cathode current collecting layer 43 is not limited to the submicron or micron structure. For example, metal nano catalyst can be infiltrated into the cathode current collecting layer 43 with submicron or micron structure by vacuum impregnation method so as to convert the submicron or micron structure into the nano structure. The metal nano catalyst can be nano Ag or nano Pd.

The first anode separator layer 21 with porous submicron or micron structure is made from a material such as LDC or LSCM perovskite, or Sr₂MgMoO₆ double-perovskite. The thickness of the first anode separator layer 21 is from 10 μm to 30 μm. The anode current collecting layer 20 has also a porous submicron or micron structure. The common materials for the anode current collecting layer 20 (before reduction) includes a nickel oxide or a mixture of nickel oxide with other metal oxides that can be reduced easily or can not be easily reduced. The metal oxides reduced easily include copper oxide, cobalt oxide, and iron oxide while the metal oxides not easily reduced are cerium oxide, LSCM, Sr₂MgMoO₆, etc. The thickness of the anode current collecting layer 20 is from 20 to 50 μm and the porosity thereof is from 30 to 50%. The anode current collecting layer 20 after hydrogen reduction should have good electron conductivity. Thus there is a high ratio of metal particles in the anode current collecting layer 20 and the metal particles is over 50 volume percent thereof. The second cathode separator layer 44 is used for preventing the cathode current collecting layer 43 and the cathode interlayer 42 from being poisoned. As shown in FIG. 2, the poison material can come from the porous metal substrate 1 and poisons the cathode current collecting layer 43 and the cathode interlayer 42 by diffusion so that the performance of a fuel cell decays with time. The second cathode separator layer 44 made from LSCM, LaCrO3 or other perovskite material such as La_{0.6}Sr_{0.2}Ca_{0.2}CrO₃ has a submicron or micron structure and has a thickness from 10 μm to 30 μm.

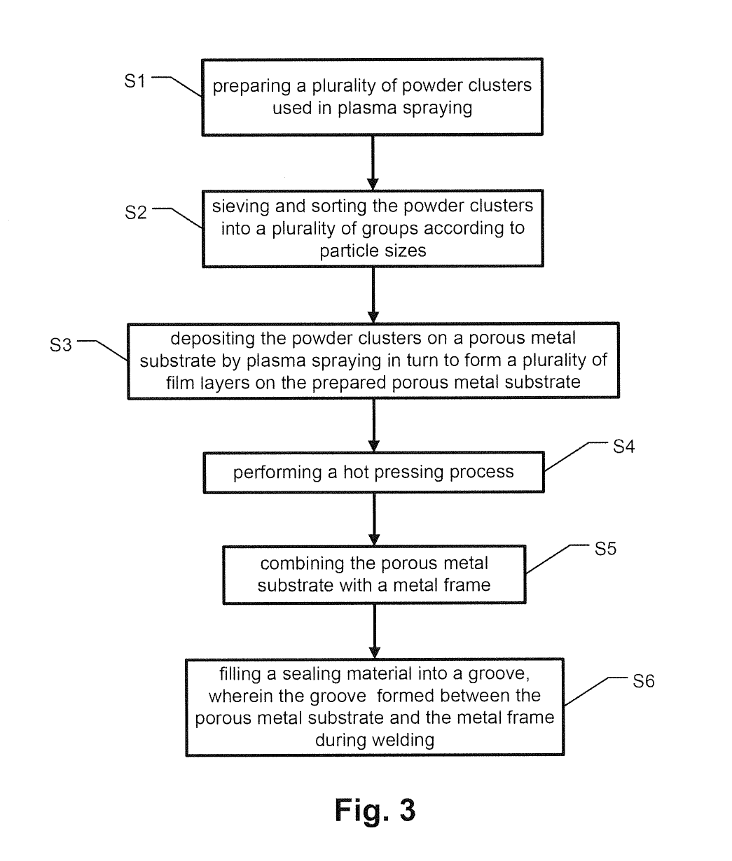

Refer to FIG. 3, a method for manufacturing a metal supported solid oxide fuel cell includes following steps:
Step S1: prepare a plurality of powder clusters used in plasma spraying;
Step S2: sieve and sort the powder clusters into a plurality of groups according to particle sizes;
Step S3: deposit the powder clusters on a porous metal substrate by plasma spraying in turn to form a plurality of film layers on the porous metal substrate.

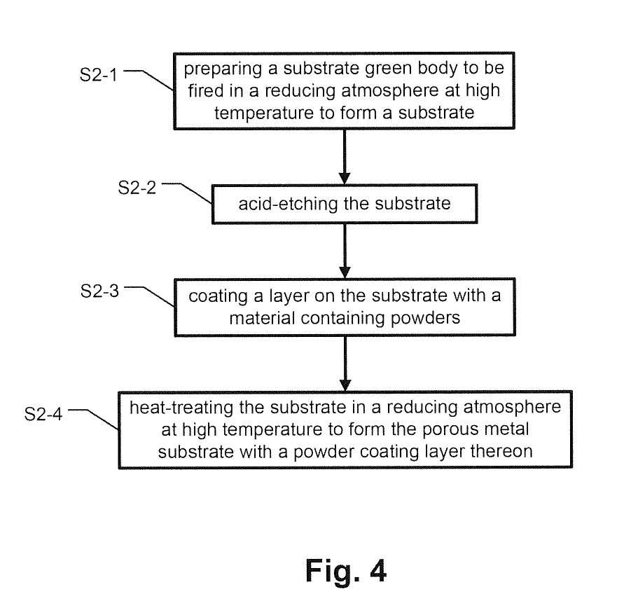

In the step S1, first prepare a plurality of powder clusters used in plasma spray torches. Then by the sieving and sorting in the step S2, the powder clusters are divided into a plurality of groups according to the particle sizes. For example, there are four groups such as 10˜20 μm, 20˜30 μm, 30˜50 μm and 50˜70 μm. Besides the sieving and sorting in the step S2, refer to FIG. 4, the user also needs to perform following steps at the same time for preparing the porous metal substrate 1.
Step S2-1: prepare a substrate green body to be fired in a reducing atmosphere at high temperature to form a substrate;
Step S2-2: acid etch the substrate;
Step S2-3: coat a surface of the substrate with a material containing powders; and
Step S2-4: heat-treat the substrate to form the porous metal substrate with a powder coating layer thereon in a reducing atmosphere at high temperature.

These steps for preparing the porous metal substrate 1 are independent to the step S1 and step S2 mentioned above. After the porous metal substrate and all materials being well prepared, then run the step S3.

In the case that the produced porous metal substrate 1 is a nickel-iron porous substrate used in a reducing atmosphere, a first anode separator layer 21, an anode interlayer 22, a second anode separator layer 23, an electrolyte layer 3, a first cathode separator layer 41, a cathode interlayer 42, a cathode current collecting layer 43 and a second cathode separator layer 44 are sequentially formed over the powder coating layer on the surface of the porous metal substrate 1, as shown in FIG. 1A. In the case that the produced porous metal substrate 1 is a porous ferritic stainless steel substrate used in an oxygen oxidation atmosphere, a second cathode separator layer 44, a cathode current collecting layer 43, a cathode interlayer 42, a first cathode separator layer 41, an electrolyte layer 3, a second anode separator layer 23, an anode interlayer 22, an anode current collecting layer 20, and a first anode separator layer 21 are sequentially formed over the powder coating layer of the ferritic stainless steel substrate, as shown in FIG. 2.

In each of the above cells, at least one of the layers is formed by high voltage medium current tri-gas atmospheric plasma spraying process. The tri-gas includes argon, helium and hydrogen or argon, helium and nitrogen. The metal supported solid oxide fuel cell of the present invention is produced by the high voltage medium current tri-gas atmospheric plasma spraying process to avoid disadvantages of high temperature sintering.

For getting better qualities and higher performances of fuel cells, the step S4 is applied to perform a hot pressing process to increase performance and reliability of the metal supported solid oxide fuel cell, and then the step S5 is used to combine the porous metal substrate 1 and the metal frame 5 by laser welding. Finally in step S6, a groove 7 containing the welded junction is filled with sealing materials 6. The sealing materials 6 can be glass sealants or glass-ceramic sealants and is in contact with the electrolyte layer 3 to avoid gas leakages through the groove 7 and the edges of porous layers beneath the electrolyte layer 3.

In the step S2-1, solid nearly-round nickel powders are formed through the melting and atomizing nickel bars with a diameter of 1˜2 mm by high temperature plasma flame. The nickel bar is delivered into the high temperature center of plasma flame at a speed of 120˜150 cm/min in an atmosphere of inert gas or vacuum. The electric power applied to the plasma torch is 20˜25 kW and the flow of argon gas for forming plasma flame is 50˜60 slpm. After screening the produced nickel powders, nickel powders with the particle sizes of 40˜250 μm are selected and added with molybdenum (Mo) powders or molybdenum (Mo) powders together with iron oxide powders. The weight percentage of Mo powders or molybdenum (Mo) powders together with iron oxide powders is less than 16 wt %, and the weight percentage of iron oxide powders is less than 8 wt %. A solution containing an organic binder and a solvent is added into the powders mentioned above, and then the mixture is uniformly stirred to form a metal slurry. The commonly used organic binder includes polyvinyl alcohol (PVA), methyl cellulose and hydroxypropyl methyl cellulose (HPMC), and the solvent is deionized water. A planar or tubular green body is formed by the rolling or extrusion and drying processes. Then the green body is sintered at a high temperature (1150˜1350° C.) in a reducing atmosphere (hydrogen) for 3 to 6 hours. After cooling to room temperature, the production of the porous NiFe substrate or NiMo substrate or NiFeMo substrate is finished. Then the step S2-1 is completed. For producing better green bodies with different shapes, the metal slurry may contain a plasticizer such as PEG (polyethylene glycol) to improve the formation of the green bodies. The addition of iron and molybdenum elements into the porous metal substrate is to increase the high temperature mechanic strength and to reduce the thermal expansion coefficient of the porous metal substrate for getting a better match with the functional layers of a fuel cell. The iron can also absorb oxygen efficiently and increase the redox stability of a fuel cell by iron oxidation reaction The above slurry ingredients and the method for producing the green body are only an embodiment of the present invention, but not limited to this embodiment.

Besides the above method, the substrate can be produced by firstly preparing a porous nickel substrate and then materials having Fe and Mo elements (such as iron oxide, molybdenum oxide or Mo metal powders) are infiltrated into the porous nickel substrate by vacuum impregnation. Moreover, the substrate can also be produced by firstly preparing a porous nickel-molybdenum substrate and then the material containing Fe element (such as iron oxide powders) is infiltrated into that porous substrate by vacuum impregnation. After high temperature sintering (1150˜1350° C.) in a reducing atmosphere, a porous NiFe substrate, NiMo substrate, or NiFeMo substrate is formed. The weight percentage of Mo powders or molybdenum (Mo) powders together with iron oxide powders is less than 16 wt %, and the weight percentage of iron oxide powders is less than 8 wt %.

In the step S2-2, the formed porous NiFe substrate or NiMo substrate or NiFeMo substrate is soaked in acidic solution for cleaning and etching. The time for soaking the prepared substrate in diluted hydrochloric acid and nitric acid is 10 to 30 minutes. The acidic solution used in the present invention is prepared by adding 10 to 50 cc nitric acid into 1000 cc deionized water. The acid etching can increase the gas permeability of prepared substrates.

In the step S2-3, the surface of a prepared porous NiFe substrate or NiMo substrate or NiFeMo substrate is coated with material containing coarse metal powders (25˜50 μm) under vacuum suction and the coated surface is scraped off by a plastic scraper. Then in the step S2-4, a heat treatment is performed in a reducing atmosphere at high temperature (1100˜1250° C.). After this heat treatment, the steps of S2-3 and S2-4 are repeated by coating the material containing fine powders (˜10 μm) on the coated surface containing coarse powders. For simplicity, the material containing a mixture of coarse and fine powders can also be coated on the prepared substrate in the step S2-3 and then apply heat treatment in a reducing atmosphere at high temperature (1100˜1250° C.) in the step S2-4. The material to be coated can be in a powder form or in a paste form, for example, the nickel powders or the paste containing nickel powders can be used as a powder coating material. Besides nickel powders, other metals such as iron, copper, cobalt, etc. can be added into the powders or a paste to be coated. After coating powders or pastes on the surface thereof, the pore sizes on the surface of a porous NiMo substrate or NiMo substrate or NiFeMo substrate is smaller than 30 μm and the permeability of treated substrate is in the range of from 1.5 to 2 Darcy. If the substrate permeability is not in this range, it can be improved by acid etching. The added elements of iron, copper and cobalt can absorb oxygen by oxidation reactions to increase the redox-stability of solid oxide fuel cells supported by the prepared porous metal substrates.

The steps for manufacturing the porous metal substrate made from ferritic stainless steels or nickel alloys containing iron, molybdenum and chromium are the same as those for manufacturing the porous NiMo or NiFeMo substrate. Other porous metal substrates that can be coated by plasma spray and can be applied in hydrogen reduction or oxygen oxidation environments can also be used.

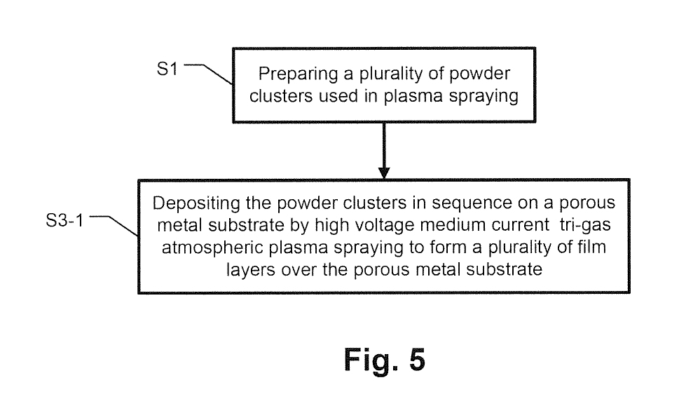

In the step S3, the present invention produces a plurality of functional layers of a solid oxide fuel cell by high voltage medium current tri-gas atmospheric plasma spraying to increase coating quality and efficiency. Refer to FIG. 5, a method for manufacturing a metal supported solid oxide fuel cell includes following steps:
Step S1: prepare a plurality of powder clusters used in plasma spraying;
Step S3-1: deposit the powder clusters in sequence on a porous metal substrate by high voltage medium current tri-gas atmospheric plasma spraying to form a plurality of film layers over the prepared porous metal substrate.

The details of the step S1 and the step S3-1 shown in FIG. 5 are described in the following. The present invention uses unique high voltage medium current tri-gas atmospheric plasma spraying to produce sequentially the first anode separator layer 21, the anode interlayer 22, the second anode separator layer 23, the electrolyte layer 3, the first cathode separator layer 41, the cathode interlayer 42, the cathode current collecting layer 43 and the second cathode separator layer 44 as shown in FIG. 1A, or uses unique high voltage medium current tri-gas atmospheric plasma spraying to produce sequentially the second cathode separator layer 44, the cathode current collecting layer 43, the cathode interlayer 42, the first cathode separator layer 41, the electrolyte layer 3, the second anode separator layer 23, the anode interlayer 22, the anode current collecting layer 20, and the first anode separator layer 21 as shown in FIG. 2. Thus the layer quality, especially the electrolyte layer, is increased and the cell performance is improved. Yet the production of the layers mentioned above is not limited to the high voltage medium current tri-gas atmospheric plasma spraying.

The extended arc length of high voltage medium current tri-gas atmospheric plasma spraying of the present invention increases the heating time of injected powder clusters. Thereby the powders are heated efficiently and the deposited layers have better quality. Moreover, the lifetime of cathode or anode of an atmospheric plasma spraying gun increases due to smaller working current. This result in reducing the production cost. The high voltage medium current tri-gas atmospheric plasma spraying process has features of high voltage, medium current and high enthalpy (heat content). The plasma forming gas used in the high voltage medium current tri-gas atmospheric plasma spraying process is a mixture of argon, helium, and hydrogen or a mixture of argon, helium, and nitrogen so as to generate high enthalpy and high speed atmospheric plasma flame to heat the injected powders. In the case of using a mixed gas of argon, helium and hydrogen, the argon flow rate is 49˜60 slpm, the helium flow rate is 20˜27 slpm and the hydrogen flow rate is 2˜10 slpm. In the case of using a mixed gas of argon, helium and nitrogen, the flow rates of argon and helium are the same and the nitrogen flow rate is 2˜10 slpm.

Moreover, the working voltage of the plasma spray gun used in high voltage medium current tri-gas atmospheric plasma spraying process can be varied according to the needs of coating different materials. The working voltage and the temperature of a plasma flame can be adjusted by changing the hydrogen flow rate or the nitrogen flow rate. The temperature of a plasma flame can also be adjusted by changing the working current of a plasma spray gun. While coating the denser layer such as the electrolyte layer 3, the plasma spraying with higher power is used and the common value of working voltage is larger than 100±1 Volt. For coating the porous layer such as the anode interlayer 22, the anode current collecting layer 20, the cathode interlayer 42 or the cathode current collecting layer 43, the plasma spraying with lower power is applied and the common value of working voltage is larger than 86±1 Volt. Thus various plasma spraying powers applied for coating different layers are obtained by adjusting the working current of a plasma spray gun. The spray parameters of the high voltage medium current tri-gas atmospheric plasma spraying process of the present invention can be varied according to different requirements of different layers of a solid oxide fuel cell conveniently and fast. People skilled in the art can change the parameters according to the practical conditions.

The powder clusters in this embodiment are micron-scale powder clusters with nano/submicron/micron structure and agglomerated by PVA organic binder. Besides powder clusters agglomerated by the organic binder such as PVA, the sintered and crushed powder clusters can also be used. As the powder clusters are delivered into a plasma flame, the organic binder is burned out immediately while the residues of injected powders are heated and accelerated to molten or semi-molten states and are deposited to form the layers. For production of the anode interlayer 22 and the cathode interlayer 42, micron-scale powder clusters with nano structure or submicron-structure are used in the present invention.

While manufacturing the cathode current collecting layer 43 with submicron or micron structure, the micron-scale powder clusters formed by mixing micron/submicron-powders with PVA organic binder are used. The particle sizes of the powder cluster is not limited, for example, the powder cluster can also be formed by a part of nano powders, a part of submicron-powders and a part of micron-powders agglomerated by PVA organic binder. There is no restriction on the organic binder.

No matter which kind of powder cluster is used, the present invention features on that the powder clusters are sieved and sorted into a plurality of groups of powder clusters according to the sizes of powder cluster. In this embodiment, there are four groups of powder clusters, including 10˜20 μm, 20˜30 μm, 30˜50 μm and 50˜70 μm. Only one group of powder clusters is injected into the high temperature plasma flame generated by the plasma spraying power optimized for heating efficiently the selected group of powder clusters into a molten or semi-molten state. Moreover, there are different ways to inject the sieved powder clusters into the plasma flame. Taking a commercial SG100 plasma spray gun as an example, the powder injection way includes internal injection and external injection. Once the powder clusters contain materials with high melting-point, these powder clusters are injected into the high temperature area of the plasma flame by internal injection. If the powder clusters contain materials with low melting-point, it is injected into the low temperature area of the plasma flame by external injection. For producing the layer with a dense structure such as the dense electrolyte layer 3, the powder clusters are injected into the high temperature area of the plasma flame by internal injection. While producing the layer with porous structure, the powder clusters are injected into the low temperature area of the plasma flame by external injection. Taking a commercial TriplexPro-200 plasma spray gun as an example, the powder clusters can only be injected into the plasma flame by external injection, thus a lower plasma spraying gun power is used while a porous layers is manufacturing, but a higher plasma spraying gun powder is used while a dense layer is manufacturing.

Back to FIG. 1A, during manufacturing process of the first anode separator layer 21 and the anode interlayer 22, the porous metal substrate 1 is heated up to 650˜750° C. Then the injected corresponding powder clusters are heated by the high temperature plasma flame generated in the high voltage medium current tri-gas atmospheric plasma spraying process. Finally, the first anode separator layer 21 and the anode interlayer 22 are formed on the porous metal substrate 1. Taking a SG100 plasma spray gun as an example, the internal injection with a low gun power is applied not only to have sufficient porosities of the first anode separator layer 21 and the anode interlayer 22 but also to improve the adhesion between the first anode separator layer 21 and the porous metal substrate 1 as well as the adhesion between the anode interlayer 22 and the first anode separator layer 21.

During the manufacturing processes of the second anode separator layer 23 and the electrolyte layer 3, the porous metal substrate 1, the first anode separator layer 21 and the anode interlayer 22 are heated up to 750˜900° C. in the beginning. Then the power clusters of second anode separator layer 23 and the electrolyte layer 3 are injected, heated and formed the corresponding layers over the anode interlayer 22 in turn by the high voltage medium current tri-gas atmospheric plasma spraying. If the solid oxide fuel cell is operated in an environment with the temperature lower than 700° C., it is possible to have no need for producing the second anode separator layer 23 and/or the first cathode separator layer 41. Moreover, in order to make the injected powder clusters melt well and get a dense structure of the second anode separator layer 23 or the electrolyte layer 3, the internal injection of power clusters is preferred in the case of using a high power SG100 plasma spray gun. If the powder clusters are delivered to a TriplexPro-200 plasma spray gun, a higher gun power is usually needed for the external injection of power clusters.

In the embodiment, the first cathode separator layer 41 is made from LDC, YDC, GDC, SDC or other materials that do not react with adjacent layers and have sufficient oxygen ion conductivities. The thickness of the first cathode separator layer 41 ranges from 5 μm to 15 μm. The functions of the first cathode separator layer 41 are similar to those of the second anode separator layer 23. The powder injection methods for producing the first cathode separator layer 41 and the second anode separator layer 23 are the same. Before coating the first cathode separator layer 41, the object including the porous metal substrate 1 and previously coated layers is heated up to 750˜900° C.

During the manufacturing processes of the cathode interlayer 42 and the cathode current collecting layer 43, first the porous metal substrate 1, the first anode separator layer 21, the anode interlayer 22, the second anode separator layer 23, the electrolyte layer 3 and the first cathode separator layer 41 are heated to 650˜750° C. Then the injected powder clusters of the cathode interlayer 42 and the cathode current collecting layer 43 are heated by the high voltage medium current tri-gas atmospheric plasma spraying so as to form the cathode interlayer 42 and the cathode current collecting layer 43 over the first cathode separator layer 41 in turn. Moreover, the external injection of these powder clusters is applied to obtain porous layers with good performance. In order to increase porosity of the cathode interlayer 42 and the cathode current collecting layer 43, these powder clusters are added with carbon black pore former. In this embodiment, the amount of the carbon black pore former is less than 20 weight percent.

While manufacturing the second cathode separator layer 44, other already formed layers of a fuel cell are preheated to 650˜750° C. first, then injected powder clusters are heated by high voltage medium current tri-gas atmospheric plasma spraying so as to deposit the second cathode separator layer 44 on the cathode current collecting layer 43. While producing the second cathode separator layer 44 by the SG100 plasma spray gun with the internal injection of corresponding powder clusters, the plasma spray gun power is adjusted to obtain the porous permeable second cathode separator layer 44 with good adhesion to the cathode current collecting layer 43. The obtained second cathode separator layer 44 has a submicron or micron structure with a thickness of 10˜30 μm.

The coating process of a solid oxide fuel cell is completed after the layers shown in FIG. 1A are formed in sequence on a prepared porous metal substrate. Then the step S4 for hot pressing the coated cell is adopted to improve the performance of the solid oxide fuel cell.

The hot pressing process of step S4 is a post process of this embodiment. By hot pressing the APS coated cell at the temperature less than 1000° C. for a time of 1 to 3 hours, the ohm resistance of the cathode of an APS coated cell is significantly reduced and the output power density of the solid oxide fuel cell is significantly enhanced. Generally, the hot pressing temperature ranges from 825° C. to 950° C. and the applied pressure in the hot pressing process varies from 200 to 1000 g/cm².

In addition, the hot pressing can relax the stresses between layers formed by APS process and increases the adhesion between layers. The pressure and the temperature of the hot pressing should be proper. The temperature of hot pressing process is adjusted according to the plasma spray powers of the cathode interlayer 42 and the cathode current collecting layer 43. Usually, a higher plasma spray power used to form the cathode interlayer 42 or the cathode current collecting layer 43, a lower temperature of hot pressing process is needed. The pressure and temperature of hot pressing process increase contacts between powders in the cathode interlayer 42 and the cathode current collecting layer 43. Thus, the electric conductivity (including electron and oxygen ion) of the cathode interlayer 42 and the cathode current collecting layer 43 is significantly improved while the cathode interlayer 42 and the cathode current collecting layer 43 still remain a good permeability.

The embodiments shown in FIG. 1A and FIG. 2 have different materials of porous metal substrates that are used in different environments. For example, the porous metal substrate 1 shown in FIG. 1A is formed of the materials such as NiFe, NiMo, or NiFeMo that are used in a reduction environment and the porous metal substrate 1 shown in FIG. 2 is formed of the materials such as ferritic stainless steels that are used in an oxidation environment. Because of this reason, the layer sequences shown in FIG. 1A and FIG. 2 are different. The embodiment shown in FIG. 1A has the anode related layers close to the porous metal substrate 1, but the embodiment shown in FIG. 2 has the cathode related layers close to the porous metal substrate 1. The layers made from the same materials and with the same functions are produced by the same method and the same plasma spray parameters, and at least one layer of cells shown in FIG. 1A and FIG. 2 is manufactured by the high voltage medium current tri-gas atmospheric plasma spraying process.

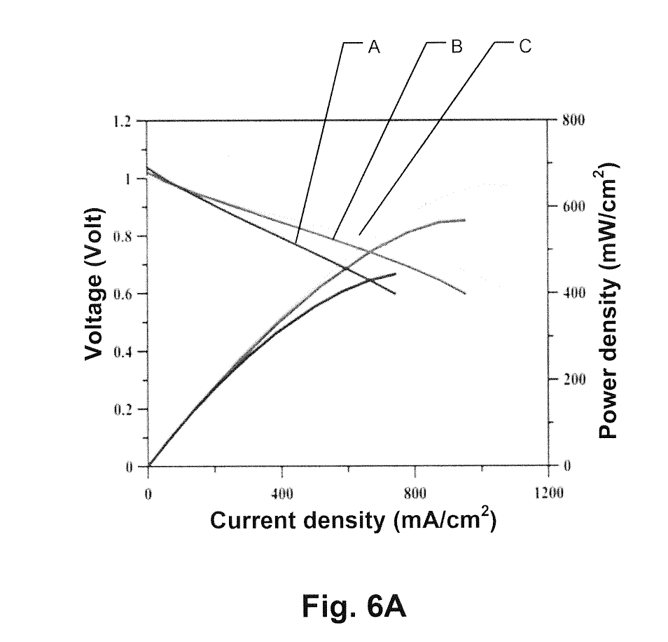

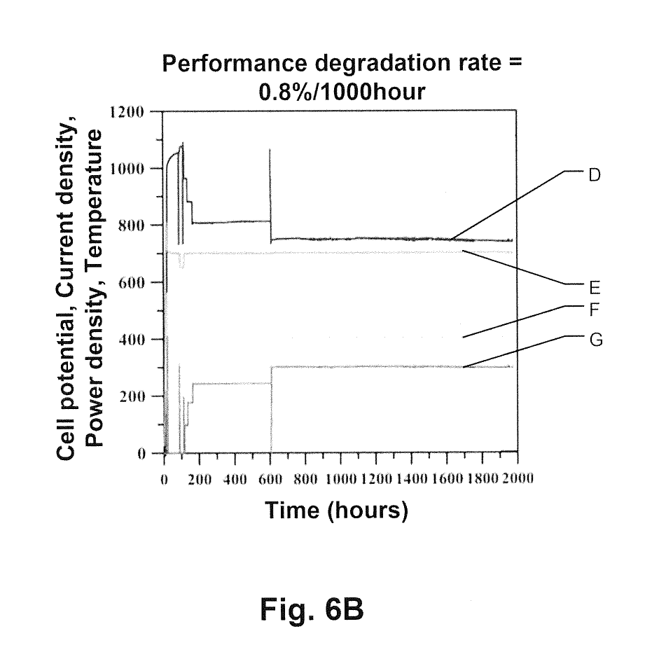

Refer to FIG. 6A and FIG. 6B, the power performance of a 10×10 cm² cell and the durability performance of a 10×10 cm² single cell stack of the embodiment shown in FIG. 1A without the first cathode separator layer 41 and the second cathode separator layer 44 are revealed. The 10×10 cm² solid oxide fuel cell has an active cathode area of 81 cm². At the working temperature of 700° C., this cell can deliver 568 mW/cm² output power density at 0.6V. The degradation rate of the single cell stack is less than 1% per 1000 hrs. The oxidant and fuel for measuring these solid oxide fuel cells are air and hydrogen. There is no limitation on the area of fuel cells disclosed in present invention. The following table gives the definitions of symbols shown in FIG. 6A and FIG. 6B.

| symbol | definition |
|---|---|
| A | measurement at 650° C. with a maximum 443 mW/cm² (0.6 V) |
| B | measurement at 700° C. with a maximum 568 mW/cm² (0.6 V) |
| C | measurement at 750° C. with a maximum 650 mW/cm² (0.6 V) |
| D | measured cell potential (Max: ~1.065 V) |
| E | measured temperature (700° C.) |
| F | measured current density (400 mA/cm²) |
| G | measured power density (Max: ~310 mW/cm²) |

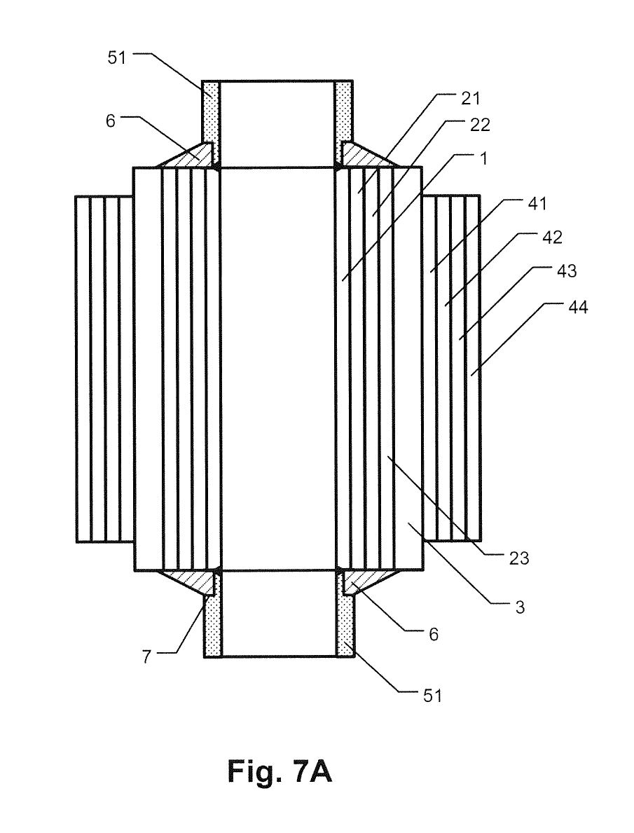

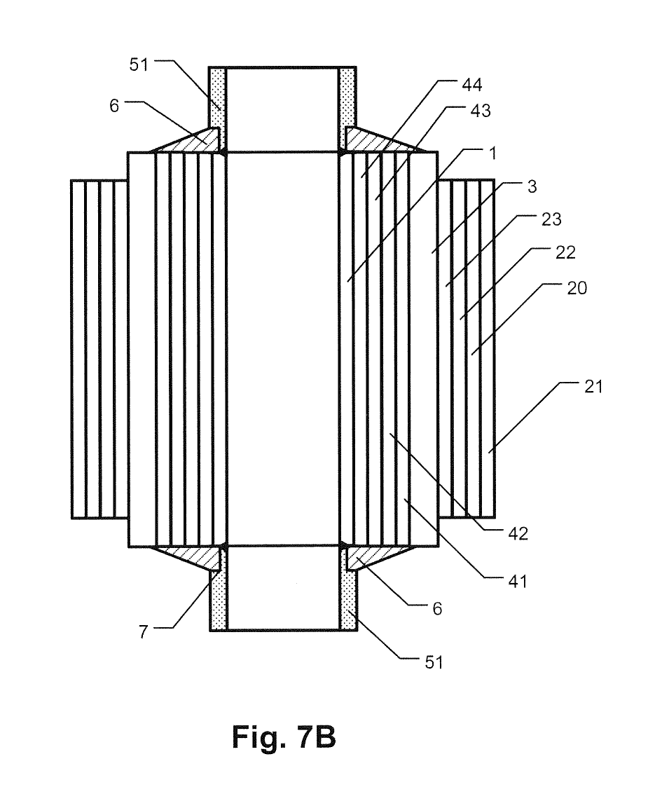

Beside the planar solid oxide fuel cells mentioned above, the solid oxide fuel cells can be tubular. The layers of a planar solid oxide fuel cell are coated on planar porous metal substrate 1 shown in FIG. 1A or FIG. 2 by X-Y scanning of plasma spray gun. The layers of a tubular solid oxide fuel cell shown in FIG. 7A and FIG. 7B are coated on a tubular porous metal substrate 1 by rotating this substrate and scanning linearly the plasma spray gun. The tubular porous metal substrate 1 can be obtained by sintering an extruded tubular green body at high temperature in a reducing atmosphere or by bending and welding the planar porous metal substrate 1. The tubular solid oxide fuel cell has higher mechanical strength than the planar solid oxide fuel cell. The tubular solid oxide fuel cells disclosed here have two types shown in FIG. 7A and FIG. 7B. The embodiments shown in FIG. 7A and FIG. 7B have also different materials of porous metal substrates that are used in different environments. The porous metal substrate 1 shown in FIG. 7A is formed of the materials such as nickel alloys that are used in a reduction environment and the porous metal substrate 1 shown in FIG. 7B is formed of the materials such as ferritic stainless steels that are used in an oxidation environment. Because of this reason, the layer sequences shown in FIG. 7A and FIG. 7B are different. The embodiment shown in FIG. 7A has the anode related layers close to the porous metal substrate 1, but the embodiment shown in FIG. 7B has the cathode related layers close to the porous metal substrate 1. The tubular solid oxide fuel cell can also be treated by hot pressing method to improve the cell performance. After finishing hot pressing process, as shown in the FIG. 7A and FIG. 7B, each end of the tubular porous tubular substrate 1 is connected to a gas tight tubular metal pipe 51 by laser welding or other welding processes. The gas tight tubular metal pipe 51 provides a path for entering the oxygen oxidant or hydrogen fuel and it is made from the same material as the metal frame 5 of the previous embodiment. A groove 7 is located at the welding position that connects the tubular porous metal substrate 1 with the gas tight tubular pipe 51. The sealing material 6 is filled into the groove 7 and in contact with the electrolyte layer 3 to avoid gas leakages through the groove 7 and the edges of porous layers beneath the electrolyte layer 3.

The following are various embodiments of the present invention.

### Embodiment 1

### Porous First Anode Separator Layer Made from LSCM (La_{0.75}Sr_{0.25}Cr_{0.5}Mn_{0.5}O₃)

The sizes of the LSCM agglomerated powder clusters are 50˜70 μm while the LSCM original particle sizes are 0.6˜2 μm. These powder clusters are transmitted by a precision powder feeder such as Sulzer Metco Twin-120 and are injected into the plasma flame by internal injection or external injection. The plasma spray parameters include plasma gases, a spray power (32˜40 kW: current 302˜359 A, voltage 106˜112V), a spray distance (9˜11 cm), a scanning speed of the plasma spray gun (500˜700 mm/sec), a powder feed rate (2˜8 g/min) and a preheat temperature of a porous nickel plate to be coated (650˜750° C.). While using SG100 plasma spray gun, the argon gas flow rate is 49˜55 slpm, the helium gas flow rate is 23˜27 slpm and the hydrogen gas flow rate 7˜9 slpm. For the TriplexPro-200 plasma spray gun, the argon gas flow rate is 49˜55 slpm, the helium gas flow rate is 23˜27 slpm and the nitrogen gas flow rate 3˜6 slpm.

### Embodiment 2

### Porous Nano Structured Anode Interlayer Made from a Mixture of LDC and Nickel

The ratio of LDC to Ni in volume is 50:50 and LDC is Ce_{0.55}La_{0.45}O₂. The agglomerated powder clusters having sizes of 20˜30 μm are formed of LDC nano particles, nickel oxide (NiO) nano particles and PVA organic binder. These powder clusters are transmitted by a precision powder feeder such as Sulzer Metco Twin-120 and are injected into the plasma flame by internal injection or external injection. The plasma spray parameters include plasma gases, a spray power (36˜44 kW: current 340˜397 A, voltage 106˜112V), a spray distance (9˜11 cm), a scanning speed of the plasma spray gun (500˜700 mm/sec), a powder feed rate (2˜8 g/min) and a preheat temperature of an object to be coated (650˜750° C.). While using SG100 plasma spray gun, the argon gas flow rate is 49˜55 slpm, the helium gas flow rate is 23˜27 slpm and the hydrogen gas flow rate 7˜9 slpm. For the TriplexPro-200 plasma spray gun, the argon gas flow rate is 49˜55 slpm, the helium gas flow rate is 23˜27 slpm and the nitrogen gas flow rate 3˜6 slpm. The anode interlayer made of LDC and nickel (LDC/Ni) is produced by hydrogen reduction of the layer made of LDC and nickel oxide (LDC/NiO).

### Embodiment 3

### Dense LDC Layer (Used as the Second Anode Separator Layer or the First Cathode Separator Layer)

The sizes of the LDC agglomerated powder clusters are 20˜30 μm while the LDC original particle sizes are less than 100 nm. These LDC powder clusters are formed of LDC nano particles and PVA organic binder. These powder clusters are transmitted by a precision powder feeder such as Sulzer Metco Twin-120 and are injected into the plasma flame by internal injection or external injection. The plasma spray parameters include plasma gases, a spray power (42˜48 kW: current 396˜453 A, voltage 106˜112V), a spray distance (8˜10 cm), a scanning speed of the plasma spray gun (800˜1200 mm/sec), a powder feed rate (2˜6 g/min) and a preheat temperature of an object to be coated (750˜850° C.). While using SG100 plasma spray gun, the internal injection is used with 49˜55 slpm argon gas flow rate, 23˜27 slpm helium gas flow rate and 7˜9 slpm hydrogen gas flow rate. For the TriplexPro-200 plasma spray gun, the external injection is used with 49˜55 slpm argon gas flow rate, 23˜27 slpm helium gas flow rate and 3˜6 slpm nitrogen gas flow rate. The operating pressure of each gas ranges from 4 kg/cm² to 6 kg/cm².

### Embodiment 4

### Gas Tight LSGM and LSGMC Layers (Electrolyte Layers) with No Cracks

The agglomerated powder clusters of LSGM or LSGMC have the sizes of 20˜30 μm and are formed of nano/submicron LSGM or LSGMC particles and PVA organic binder. These agglomerated powder clusters of LSGM or LSGMC can be pre-sintered at temperatures less than 1100° C. to remove PVA organic binder and then to be sprayed later. The other kind of powder clusters of LSGM or LSGMC is the sintered and crushed powder clusters having the sizes of 20˜30 μm and formed of LSGM or LSGMC submicron particles. These powder clusters are transmitted by a precision powder feeder such as Sulzer Metco Twin-120 and are injected into the plasma flame by internal injection or external injection. The plasma spray parameters include plasma gases, a spray power (49˜53 kW: current 462˜500 A, voltage 106˜112V), a spray distance (8˜10 cm), a scanning speed of the plasma spray gun (500˜700 mm/sec), a powder feed rate (2˜6 g/min) and a preheat temperature of an object to be coated (750˜850° C.). While using SG100 plasma spray gun, the internal injection is used with 49˜55 slpm argon gas flow rate, 23˜27 slpm helium gas flow rate and 6˜10 slpm hydrogen gas flow rate. For the TriplexPro-200 plasma spray gun, the external injection is used with 49˜55 slpm argon gas flow rate, 23˜27 slpm helium gas flow rate and 3˜6 slpm nitrogen gas flow rate. The operating pressure of each gas ranges from 4 kg/cm² to 6 kg/cm².

### Embodiment 5

### Nano Structured Porous Cathode Interlayer Made of SDC (Ce_{0.85}Sm_{0.15}O₂) and SSC (Sm_{0.5}Sr_{0.5}CoO₃)

There are two kinds of agglomerated powder clusters to be injected into the plasma flame. One is the SDC powder cluster and the other is the SSC powder cluster. The SDC powder clusters having the sizes of 20˜30 μm are formed of SDC nano particles and PVA organic binder while the SSC powder clusters having the sizes of 20˜30 μm are formed of SSC submicron particles, 15 wt % carbon black pore-former and PVA organic binder. The SDC and SSC powder clusters are delivered to a Y-shape powder mixer by a precision powder feeder such as Sulzer Metco Twin-120, and then the mixture of SDC and SSC powder clusters is delivered from the output of Y-shape powder mixer to the plasma flame by external injection. The mixture of SDC and SSC powder clusters can be mixed in a volume ratio of 50:50 or in gradient distribution by controlling the rotation speeds of powder carrying disks in Sulzer Metco Twin-120 powder feeder. The plasma spray parameters include plasma gases, a spray power (28˜33 kW: current 300˜364 A, voltage 88˜110V), a spray distance (9˜11 cm), a scanning speed of the plasma spray gun (500˜700 mm/sec), a powder feed rate (2˜8 g/min) and a preheat temperature of an object to be coated (650˜750° C.). While using SG100 plasma spray gun, the argon gas flow rate is 49˜55 slpm, the helium gas flow rate is 23˜27 slpm and the hydrogen gas flow rate is 2˜5 slpm. For the TriplexPro-200 plasma spray gun, the argon gas flow rate is 49˜55 slpm, the helium gas flow rate is 23˜27 slpm and the nitrogen gas flow rate is 3˜6 slpm.

### Embodiment 6

### Porous Cathode Current Collecting Layer Made of SSC

The agglomerated SSC powder clusters having the sizes of 20˜30 μm are formed of SSC submicron particles, 15 wt % carbon black pore former and PVA organic binder. These powder clusters are injected into the plasma flame by external injection. The plasma spray parameters include plasma gases, a spray power (27˜33 kW: current 300˜364 A, voltage 88˜110V), a spray distance (9˜11 cm), a scanning speed of the plasma spray gun (500˜700 mm/sec), a powder feed rate (2˜8 g/min) and a preheat temperature of an object to be coated (650˜750° C.). While using SG100 plasma spray gun, the argon gas flow rate is 49˜55 slpm, the helium gas flow rate is 23˜27 slpm and the hydrogen gas flow rate is 2˜5 slpm. For the TriplexPro-200 plasma spray gun, the argon gas flow rate is 49˜55 slpm, the helium gas flow rate is 23˜27 slpm and the nitrogen gas flow rate is 3˜6 slpm.

### Embodiment 7

### Solid Oxide Fuel Cell (Functional Layers: LSCM-LDC/Ni-LDC-LSGM-LDC-LSGMC-SDC/SSC-SSC) and the Porous Metal Substrate is Made from NiFe, NiMo, or NiFeMo)

The first anode separator layer is made of LSCM. The anode interlayer is made of LDC/Ni with nano structure (from LDC/NiO by hydrogen reduction). The second anode separator layer is made of LDC, the LSGM-LDC-LSGMC electrolyte layer with three-layer structure. The cathode interlayer is made of SDC/SSC with nano structure and 50:50 volume ratio, and the cathode current collecting layer is made of SSC which are respectively coated over a porous NiFe or NiMo or NiFeMo metal substrate according to the plasma spray parameters of the above six embodiments. Moreover, this embodiment doesn't include the first and the second cathode separator layers. The manufacturing of the first cathode separator layer is the same as the embodiment 3 while the manufacturing of the second cathode separator layer is the same as the embodiment 1. After finishing APS coating process of layers, the solid oxide fuel cell is treated by the hot pressing process at 825˜950° C. for 1 to 3 hours to get a better cell's performance. Finally, the produced cell is connected to the metal frame by laser welding and is applied to a single cell stack test conveniently.

The metal supported solid oxide fuel cell and the method for manufacturing the same of the present invention has a plurality of advantages. For example, there is a step of sieving and sorting powder clusters before being injected into a plasma flame to avoid insufficient heating of large-size powder clusters or overheating of small-size powder clusters. Thus, the formed layers have a better quality and a gas tight electrolyte layer can be produced. Moreover, the powder clusters injected can be agglomerated powder clusters or sintered and crushed powder clusters. The variety of the injected powder cluster is increased. The cheaper powder clusters can be used so that the cost is reduced. If the injected powder clusters are the agglomerated powder clusters, the organic binder will be burned off and then the residues are uniformed heated and melt to form the proper layer on an object to be coated as the agglomerated powder clusters enter into the plasma flame. The porous electrode layers produced by the present invention have proper porosities and evenly distributed pores. A porous electrode made of specific materials with nano structure or submicron structure or micron structure or a structure of gradient distribution can also be produced conveniently. Moreover, the acid etching during the preparation process not only removes impurities on the porous metal substrate but also improves permeability of the porous metal substrate.

In summary, the high voltage medium current tri-gas atmospheric plasma spraying of present invention has a high temperature plasma flame with extended arc, high speed and high energy to improve heating efficiency and coating efficiency of the injected powder. The tri-gas includes argon, helium and hydrogen, or argon, helium and nitrogen. This kind of plasma spraying is operated at high voltage and medium current region to reduce the electrode consumption of the plasma spray gun and increase the service life of the plasma spray gun so that the manufacturing cost of the solid oxide fuel cell is reduced. Moreover, the nano structures of the anode interlayer and the cathode interlayer have more nano scale three-phase boundaries (TPB) to improve the electric properties of a solid oxide fuel cell, and so its working temperature can also be reduced. Moreover, beside pure hydrogen gas fuel, reformed gas containing steam, hydrogen gas, carbon monoxide and methane and other gas containing methane and steam can also be used. There are various kinds of fuels able to be used. Thus the metal supported solid oxide fuel cell of the present invention with economic values and various applications.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. A structure of a metal supported solid oxide fuel cell comprising:
a metal frame;
a porous metal substrate set in the metal frame;
a first anode separator layer disposed over the porous metal substrate;
an anode interlayer disposed over the first anode separator layer and having a porous nano structure;
an electrolyte layer disposed over the anode interlayer;
a cathode interlayer disposed over the electrolyte layer and having a porous nano structure; and
a cathode current collecting layer arranged over the cathode interlayer.

2. The structure in claim 1, wherein the anode interlayer comprising a plurality of electron conducting nano particles, a plurality of oxygen ion conducting nano particles and a plurality of nano pores between electron conducting nano particles and oxygen ion conducting nano particles; the electron conducting nano particles connect to form an electron conducting 3-dimensional network, the oxygen ion conducting nano particles connect to form an oxygen ion conducting 3-dimensional network, and nano pores connect to form a 3-dimensional network for flowing gas; the size of the electron conducting nano particles is 2 to 5 times larger than the oxygen ion conducting nano particles.

3. The structure in claim 1, wherein the cathode interlayer comprising a plurality of electron-oxygen ion mixed conducting particles, a plurality of oxygen ion conducting nano particles and a plurality of nano or submicron pores between the electron-oxygen ion mixed conducting particles and the oxygen ion conducting nano particles. The electron-oxygen ion mixed conducting particles connect to form a 3-dimensional network to conduct electron and oxygen ion simultaneously, the oxygen ion conducting nano particles connect to form a 3-dimensional network to conduct oxygen ion additionally and a plurality of pores between the electron-oxygen ion mixed conducting particles and the oxygen ion conducting nano particles connect to form a 3-dimensional network for flowing gas.

4. The structure in claim 2, wherein in the anode interlayer, the material of the electron conducting nano particles is at least one selected from the group consisting of nickel, copper, cobalt, mixture of nickel and copper, and mixture of nickel, copper, and cobalt; and the material of the oxygen ion conducting nano particles is at least one selected from the group consisting of yttria stabilized zirconia (YSZ), Lanthanum-doped ceria (LDC), Gadolinia-doped ceria (GDC), Samaria-doped Ceria (SDC), strontium and magnesium-doped lanthanum gallate (LSGM) or strontium, magnesium and cobalt-doped lanthanum gallate (LSGMC).

5. The structure in claim 4, wherein the material of the anode interlayer further comprising at least one selected from the group consisting of molybdenum (Mo), palladium (Pd), perovskite La_{0.75}Sr_{0.25}Cr_{0.5}Mn_{0.5}O₃, and double perovskite Sr₂MgMoO₆.

6. The structure in claim 3, wherein in the cathode interlayer, the material of the electron-oxygen ion mixed conducting particles is at least one selected from the group consisting of LSCF, Pr_{0.6}Sr_{0.4}Co_{0.2}Fe_{0.8}O₃ (PSCF), lanthanum strontium cobalt oxide (LSCo), lanthanum strontium ferrite (LSF), SSC, Ba_{0.5}Sr_{0.5}Co_{0.2}Fe_{0.8}O₃ (BSCF) and Ba_{0.5}Pr_{0.5}Co_{0.2}Fe_{0.8}O₃ (BPCF); and the material of the oxygen ion conducting nano particles is at least one selected from the group consisting of LSGM, LSGMC, GDC, SDC, and LDC.

7. The structure in claim 1, wherein the thickness of the anode interlayer is between 10˜30 μm, the porosity thereof is 15˜30%.

8. The structure in claim 1, wherein the thickness of the cathode interlayer is between 10˜40 μm, the porosity thereof is 15˜30%.

9. The structure in claim 2, wherein in the anode interlayer, the amount of the electron conducting nano particles is in 50% of volume or increases in the area getting closer to the porous metal substrate.

10. The structure in claim 3, wherein in the cathode interlayer, the amount of the oxygen ion conducting nano particles is in 50% of volume or increases in the area getting closer to the electrolyte layer.

11. The structure in claim 1, wherein the material of the porous metal substrate used in the reduction environment is at least one selected from the group consisting of nickel, nickel-iron alloy, nickel-copper alloy, nickel-iron-copper alloy, nickel-molybdenum alloy, and nickel-molybdenum-iron alloy, wherein the weight percent of the iron is less than 20%; the porosity of the porous metal substrate is 30˜55%, and the thickness thereof is ranging from 1˜2 mm.

12. The structure in claim 11, wherein the iron in the porous metal substrate can absorb the oxygen efficiently by iron oxidation reaction to increase the redox stability of the fuel cell supported by this porous metal substrate.

13. The structure in claim 1, wherein the structure further comprising a powder coating layer disposed between the porous metal substrate and the first anode separator layer, the material of the powder coating layer is the same as the porous metal substrate, the thickness of the powder coating layer is less than 40 μm.

14. The structure in claim 13, wherein the elements of iron, copper and cobalt added in the powder coating layer can absorb oxygen by oxidation reactions to increase the redox-stability of solid oxide fuel cells supported by the prepared porous metal substrates.

15. The structure in claim 1, wherein the metal frame is gas tight, the material of the metal frame is ferritic stainless steel, iron-chromium alloy or iron-chromium-nickel alloy, and the expansion coefficient of the metal frame is 10⁻⁵˜1.4×10⁻⁵/° C., wherein the shape of the metal frame is corresponding to the shape of the porous metal substrate and is able to be a plate or a tube, the planar metal frame is disposed around the planar porous metal substrate while the tubular metal frame is disposed at each of two ends of the tubular porous metal substrate.

16. The structure in claim 1, wherein the structure further comprising a protective layer disposed on the metal frame, and the material of the metal frame is selected from the group consisting of manganese-cobalt spinel and lanthanum-strontium-manganese alloy.

17. The structure in claim 1, wherein the material of the electrolyte layer is selected from the group consisting of LSGM, LSGMC, SDC, LDC, GDC, mixed LSGM with LDC, or GDC or SDC, and mixed LSGMC with LDC, or GDC or SDC.

18. The structure in claim 17, wherein the structure of the electrolyte layer is selected from the group consisting of single-layer, double-layer, and multiple-layer, and the materials are different in different layers.

19. The structure in claim 18, wherein the total thickness of the electrolyte layer is 20˜55 μm, while the material is selected from the group consisting of LDC, GDC, SDC, LSGMC, LSGM, mixed LSGM with LDC, or GDC or SDC, and mixed LSGMC with LDC, or GDC or SDC; the thickness of each layer is 5˜50 μm.

20. The structure in claim 1, wherein the cathode current collecting layer has a submicron or micron porous structure, the material of the cathode current collecting layer is at least one selected form the group consisting of LSCF, PSCF, LSCo, LSF, SSC, BSCF and BPCF; the thickness of cathode current collecting layer is 20˜50 μm, and the porosity of cathode current collecting layer is 30˜50%.

21. The structure in claim 20, wherein the material of the cathode current collecting layer further including at least one selected from the group consisting of electrolyte material, nano Ag, and nano Pd.

22. The structure in claim 1, wherein the structure further comprising a first cathode separator layer disposed between the electrolyte layer and the cathode interlayer, the material of the first cathode separator layer is selected from the group consisting of LDC, YDC, GDC, and SDC; and the thickness thereof is 5˜15 μm.

23. The structure in claim 1, wherein the structure further comprising a second cathode separator layer disposed on the cathode current collecting layer, the material of the second cathode separator layer is at least one selected from the group consisting of LSCM, LSCoM, and La_{0.6}Sr_{0.2}Ca_{0.2}CrO₃, and the thickness thereof is 10˜30 μm.

24. The structure in claim 1, wherein the material of the first anode separator layer is selected from the group consisting LDC, LSCM, and Sr₂MgMoO₆; and the thickness of the first anode separator layer is 10˜30 μm, the porosity thereof is 15˜30%.

25. The structure in claim 1, wherein the structure further comprising a second anode separator layer disposed between the anode interlayer and the electrolyte layer, the material of the second anode separator layer is selected from the group consisting of LDC, YDC, GDC, and SDC; and the thickness thereof is 5˜15 μm.

26. A structure of a metal supported solid oxide fuel cell comprising:
a metal frame;
a porous metal substrate disposed in the metal frame;
a second cathode separator layer disposed over the porous metal substrate;
a cathode current collecting layer disposed over the second cathode separator layer;
a cathode interlayer disposed over the cathode current collecting layer and having a porous nano structure;
an electrolyte layer disposed over the cathode interlayer;
an anode interlayer disposed over the electrolyte layer and having a porous nano structure;
an anode current collecting layer disposed over the anode interlayer; and
a first anode separator layer disposed over the anode current collecting layer.

27. The structure in claim 26, wherein the material of the second cathode separator layer is selected from the group consisting of La_{0.75}Sr_{0.25}Cr_{0.5}Mn_{0.5}O₃ (LSCM), La_{0.75}Sr_{0.25}Co_{0.5}Mn_{0.5}O₃ (LSCoM), and La_{0.6}Sr_{0.2}Ca_{0.2}CrO₃; and the thickness thereof is 10˜30 μm.

28. The structure in claim 26, wherein the structure further comprising a powder coating layer disposed between the porous metal substrate and second cathode separator layer.

29. The structure in claim 26, wherein the structure further comprising a second anode separator layer disposed between the anode interlayer and the electrolyte layer, the material of the second anode separator layer is selected from the group consisting of LDC, YDC, GDC, and SDC; and the thickness thereof is 5˜15 μm.

30. The structure in claim 26, wherein the structure further comprising a first cathode separator layer disposed between the electrolyte layer and the cathode interlayer, the material of the first cathode separator layer is selected from the group consisting of LDC, YDC, GDC, and SDC; and the thickness thereof is 5˜15 μm.

31. The structure in claim 26, wherein the material of the porous metal substrate used in the oxidation environment is at least one selected from the group consisting of ferritic stainless steels, nickel alloys containing iron, molybdenum and chromium; the porosity of the porous metal substrate is 30˜55%, and the thickness thereof is ranging from 1˜2 mm.

32. The structure in claim 26, wherein the anode current collecting layer has a submicron or micron porous structure, the material of the anode current collecting layer is mixture of nickel oxide with other metal oxides selected from the group consisting of copper oxide, cobalt oxide, iron oxide, cerium oxide, LSCM, and Sr₂MgMoO₆; and the thickness of the anode current collecting layer is 20˜50 μm and the porosity thereof is 30˜50%.

33. The structure in claim 26, wherein the structure further comprising a first anode separator layer disposed over the anode current collecting layer, the material of the first anode separator layer is selected from the group consisting of LDC or LSCM perovskite, or Sr₂MgMoO₆; and the thickness thereof is 10˜30 μm.

34. The structure in claim 26, wherein the structure further comprising a protective layer disposed on the metal frame; and the material of the metal frame is selected from the group consisting of manganese-cobalt spinel and lanthanum-strontium-manganese alloy.

35. A method of manufacturing a metal supported solid oxide fuel cell comprising the steps:
preparing a plurality of powder clusters used in plasma spraying;
sieving and sorting the powder clusters into a plurality of groups according to particle sizes; and
depositing the powder clusters on a porous metal substrate by plasma spraying in turn to form a plurality of film layers on the prepared porous metal substrate;
wherein the materials of the film layers are corresponding to the materials of the powder clusters which are being sprayed.

36. The method in claim 35, wherein the sizes of the sieved and sorted powder clusters comprise 10˜20 μm, 20˜30 μm, 30˜50 μm, and 50˜70 μm.

37. The method in claim 35, wherein the steps of manufacturing the porous metal substrate comprising:
preparing a substrate green body to be fired in a reducing atmosphere at high temperature to form a substrate;
acid-etching the substrate;
coating a layer on the substrate with a material containing powders; and
heat-treating the substrate in a reducing atmosphere at high temperature to form the porous metal substrate with a powder coating layer thereon.

38. The method in claim 37, wherein the porous metal substrate is a porous nickel substrate or a porous nickel-molybdenum substrate, and after the metal substrate is formed, the method further comprising a step:
adding iron oxide powders or iron oxide and molybdenum powders into the formed porous nickel substrate by vacuum impregnation, or adding iron oxide powders into the formed porous nickel-molybdenum substrate by vacuum impregnation; and
sintering at high temperature in a reducing atmosphere;
wherein the weight percentage of Mo powders or molybdenum (Mo) powders together with iron oxide powders is less than 16 wt %, and the weight percentage of iron oxide powders is less than 8 wt %.

39. The method in claim 37, wherein in the step of coating a layer on the substrate with a material containing powders, the surface of the substrate is coated by the material that is the same as the porous metal substrate.

40. The method in claim 37, wherein in the step of the substrate is firing, the substrate is fired at 1150˜1350° C. in hydrogen for 3˜6 hours, then cooling to room temperature.

41. The method in claim 35, wherein after the film layers is formed, the method further comprising a step: performing a hot pressing process.

42. The method in claim 41, wherein in the step of performing a hot pressing process, the process temperature is at 825˜950° C., the process pressure is 200˜1000 g/cm² and the process time is 1 to 3 hours.

43. The method in claim 41, wherein after the step of performing a hot pressing process, the method further comprising a step: combining the porous metal substrate with a metal frame.

44. The method in claim 35, wherein the powder clusters are micron scale powder clusters with nano, submicron or micron structure and agglomerated by PVA.

45. The method in claim 35, wherein the powder clusters are sintered and crushed powder clusters.

46. The method in claim 43, wherein after combining the porous metal substrate with a metal frame, the method further comprising a step: filling a sealing material into a groove, wherein the groove is formed at the position between the porous metal substrate and the metal frame.

47. The method in claim 46, wherein the sealing material filled into a groove is in contact with the electrolyte layer to avoid gas leakages through the groove and the edges of porous layers beneath the electrolyte layer.

48. The method in claim 35, wherein the film layers formed on the porous metal substrate comprise a first anode separator layer, an anode interlayer, an electrolyte layer, a cathode interlayer, and a cathode current collecting layer, respectively.

49. The method in claim 35, wherein the film layers formed on the porous metal substrate comprise a second cathode separator layer, a cathode current collecting layer, a cathode interlayer, an electrolyte layer, an anode interlayer and an anode current collecting layer.

50. The method in claim 35, wherein at least one of film layers coated on the prepared porous metal substrate by plasma spraying is deposited by high voltage (>87V) medium current (<510 A) tri-gas atmospheric plasma spraying.

51. The method in claim 35, wherein if the porous metal substrate is a planar substrate, the deposition of the powder clusters is by X-Y axis scanning during the plasma spray process; and if the porous metal substrate is a tubular substrate, the deposition of the powder clusters is by rotation of the porous metal substrate and linear scanning.

52. The method in claim 50, wherein the three different gases used in the tri-gas plasma spraying are argon, helium and hydrogen or argon, helium and nitrogen.
